(19) United States
(12) Patent Application Publication
(10) Pub. No.: US 2023/0216282 A1
(43) Pub. Date: Jul. 6, 2023

(54) SNAP PLUG FOR CABLE TRAY

(71) Applicant: Eaton Intelligent Power Limited, Dublin (IE)

(72) Inventors: Amol Khalkar, Nashik (IN); Samruddha Kulkarni, Pune (IN)

(73) Assignee: Eaton Intelligent Power Limited, Dublin (IE)

(21) Appl. No.: 18/068,730

(22) Filed: Dec. 20, 2022

Related U.S. Application Data
(60) Provisional application No. 63/294,962, filed on Dec. 30, 2021.

(51) Int. Cl. H02G 3/04

(52) U.S. Cl. CPC H02G 3/0456; H02G 3/0406

(57) ABSTRACT

A cable tray including a pair of generally parallel spaced-apart side rails, each side rail defining a plurality of openings. Rungs extend between the rails at intervals spaced along the rails. Each rung includes at least two side walls. Each rung has opposite open ends generally aligned with respective openings in the side rails. End portions of each rung define a transverse opening. A plurality of snap plug fasteners fastens the rungs to the side rails. Each snap plug fastener includes a main body abutting an outboard surface of one of the side rails. A projection extends through one of the openings in the side rail and into one of the open ends of one of the rungs. The projection includes a barb received in one of the transverse openings in the rung.

### CROSS-REFERENCE TO RELATED APPLICATION

This application claims the benefit of U.S. Provisional Patent Application Ser. No. 63/294,962, filed on Dec. 30, 2021, the entire disclosure of which is incorporated herein by reference.

### FIELD

The present disclosure relates to snap plugs for a cable tray, and more particularly to a snap plug for coupling a rung to a rail in a ladder-type cable tray.

### BACKGROUND

Conventional ladder-type cable trays comprise a pair of parallel side rails and a series of spaced-apart rungs extending between the rails, the rails and rungs typically being of extruded aluminum (although they may also be steel parts or, as in the instant case, fiberglass). It has been conventional practice in the industry to secure the rungs to the rails by welding, screws, or glue.

### SUMMARY OF THE DISCLOSURE

In one aspect, a cable tray generally comprises a pair of generally parallel spaced-apart side rails. Each side rail defines a plurality of openings. Rungs extend between the rails at intervals spaced along the rails. Each rung comprises at least two side walls. Each rung has opposite open ends generally aligned with respective openings in the side rails. End portions of each rung define a transverse opening. A plurality of snap plug fasteners fasten the rungs to the side rails. Each snap plug fastener includes a main body abutting an outboard surface of one of the side rails. A projection extends through one of the openings in the side rail and into one of the open ends of one of the rungs. The projection includes a barb received in one of the transverse openings in the rung.

In another aspect, a snap plug fastener for coupling a cable tray rung to a cable tray rail generally comprises a main body defining a central opening. A plurality of projections extend outward from the main body. Each projection includes a barb disposed on an end of the projection. The projections are configured to extend through aligned openings in the cable tray rail and rung. The barb is configured to be received in a transverse opening in the rung to secure the rung to the rail.

In yet another aspect, a method of coupling a cable tray rung to a cable tray rail generally comprises aligning an opening defined by a vertical web of the cable tray rail with an open end of the cable tray rung, wherein the cable tray rung has an end portion defining a plurality of transverse openings. Inserting a snap plug fastener through the vertical web opening and into the open end of the cable tray rail, such that barbs disposed on ends of projections of the fastener are received in the transverse openings in the cable tray rung. Inserting a rod into the snap plug fastener such that the rod engages inward-facing surfaces of the projections to force the barbs outward, locking the barbs in the transverse openings.

### BRIEF DESCRIPTION OF THE DRAWINGS

FIG. 1 is a perspective view of a ladder-type cable tray including a plurality of rungs secured to spaced apart rails by a plurality of snap plug fasteners;

FIG. 2 is an enlarged fragmentary perspective view of the cable tray;

FIG. 3 is an enlarged fragmentary perspective view of the cable tray showing a rail and rung as transparent and a snap plug fastener inserted through the rail and rung;

FIG. 4 is a bottom enlarged fragmentary perspective cross-sectional view of the cable tray showing the snap plug fastener fastening the rung to the rail;

FIG. 5 is a top enlarged fragmentary perspective cross-sectional view of the cable tray showing the snap plug fastener fastening the rung to the rail;

FIG. 6 is a perspective view of the snap plug fastener;

FIG. 7 is a side enlarged fragmentary cross-sectional view of the snap plug serrated barb in relation to the opening of the rung; and

FIG. 8 is an enlarged fragmentary perspective view of the cable tray showing a rail and rung as transparent and a rod inserted into the snap plug fastener.

Corresponding reference characters indicate corresponding parts throughout the drawings.

### DETAILED DESCRIPTION

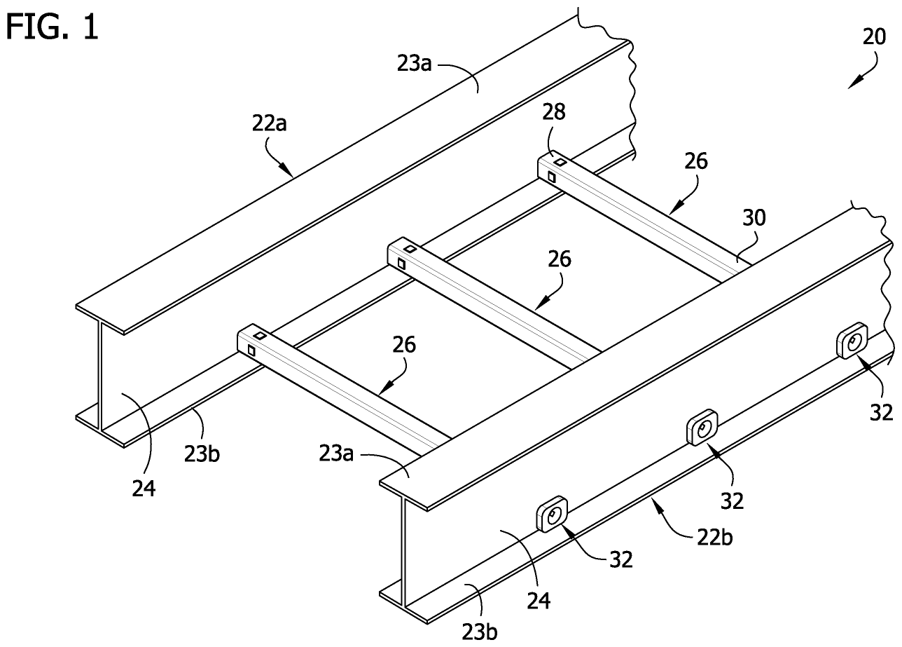

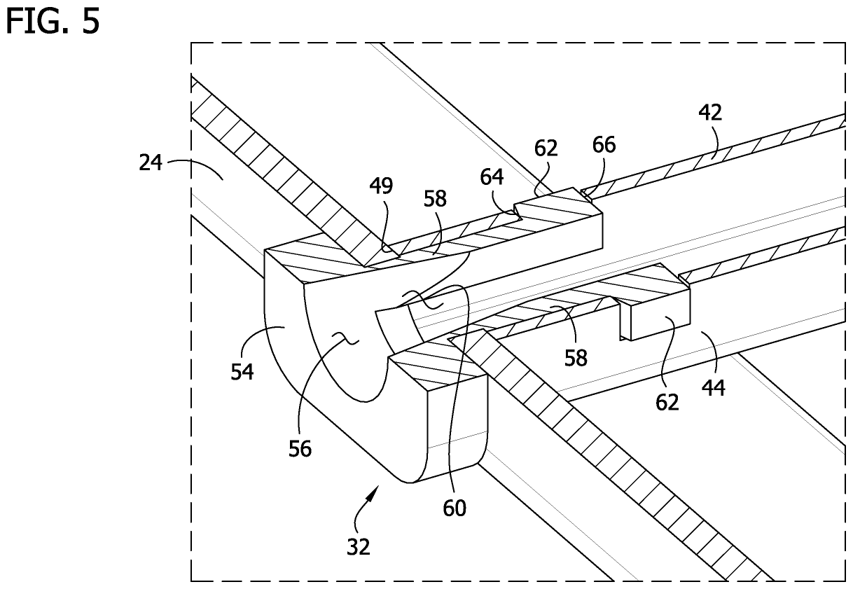

Referring now to the drawings, and more particularly to FIGS. 1-5, a ladder-type cable tray of the present disclosure is indicated in its entirety by reference numeral 20. The cable tray 20 comprises first and second generally parallel spaced-apart metal side rails, generally designated 22a, 22b, having upper and lower flanges 23a, 23b and a vertical web 24 extending between the upper and lower flanges, and a plurality of metal rungs, each generally designated 26, extending between and connected to the webs of the rails at intervals spaced along the rails. Each rung 26 has first and second opposite ends 28, 30 abutting the first and second side rails 22, 24, respectively. As explained below, a snap plug, generally designated 32, extends through the side rails 22a, 22b and into the opposite ends 28, 30 of the rungs 26 to fasten the rungs to the side rails.

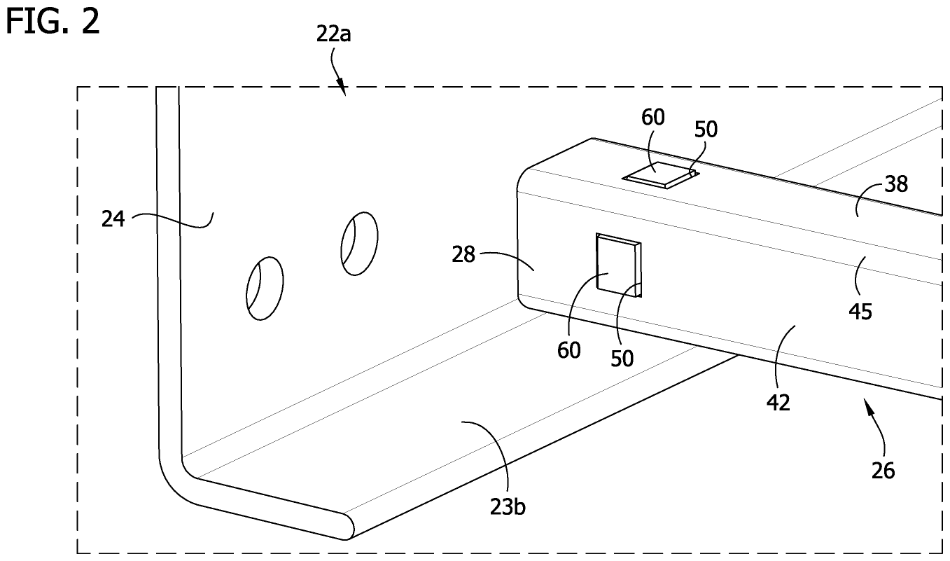

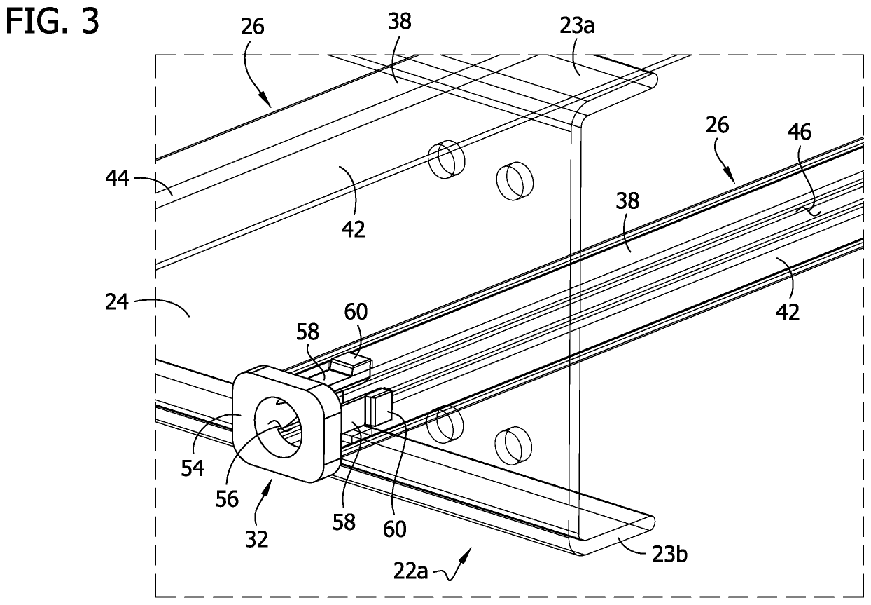

Referring to FIGS. 2 and 3, each rung 26 has generally horizontal upper and lower side walls 38, 40 and first and second vertical side walls 42, 44 connecting the upper and lower side walls. In one exemplary use, electrical cable and wire may be placed in the cable tray 20 such that the cable and wire rest on the upper side wall 38 of the rungs 26. In the illustrated embodiment, each corner where the upper side wall 38 meets the vertical side walls 42, 44 and where the lower side wall 40 meets the vertical side walls 42, 44, has a smooth surface with edge margins 45 to avoid snagging or damage to the electrical cable and wire. The edge margins 45 also define rounded edges to avoid slicing or snagging the electrical cable and wire. The rungs 26 are hollow defining an interior space 46. Further, each of the opposite ends 28, 30 of the rung 26 define axial openings 49. The axial openings 49 communicate with the interior space 46. In the illustrated embodiment, the interior space 46 extends continuously between the axial openings 49. However, the interior space 46 could extend only partly along the length of the rungs 26. Additionally, the end margins of the rungs 26 define transverse openings 50. In the illustrated embodiment, the transverse openings 50 are defined by each of the horizontal upper and lower 38, 40 and vertical first and second side walls 42, 44. The transverse openings 50 also communicate with the interior space 46. Typically, the ends 28, 30 of the rung 26 remain open, although it is foreseen that the ends may contain end walls defining an opening for passage of a snap plug 32. It is understood that the rungs 26 may be of other configurations without departing from the scope of the claimed invention. It is envisioned that the rungs and rails are formed from fiberglass, although they could also be constructed from aluminum or any other suitable material.

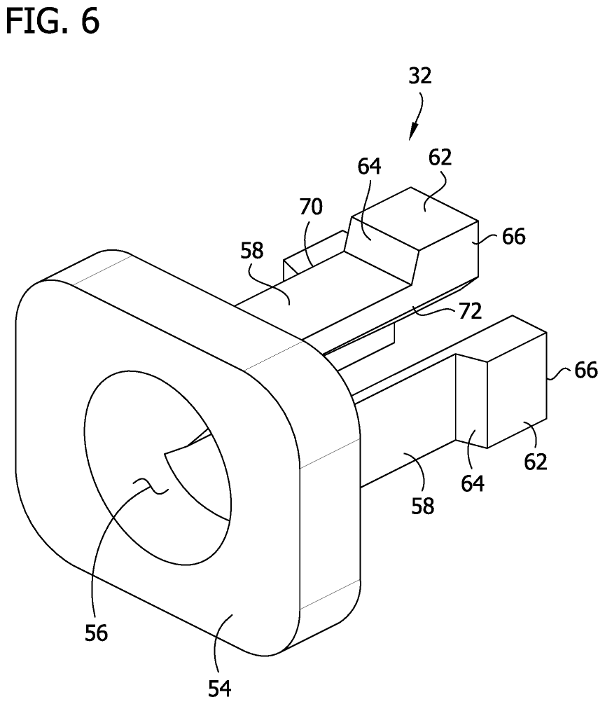

As shown best in FIG. 6, the snap plug 32 comprises a main body 54 and a plurality of projections 58 extending from the main body 54. The main body 54 is generally planar having a plate-like configuration with an opening 56 defined in a central portion thereof. For example, in the illustrated embodiment, the main body 54 is generally square-shaped plate with rounded corners, although it will be understood that a variety of sizes and shapes could be desirable. The projections 58 extend outwardly from an interior surface of the main body 54. Free end of projections 58 contain a barb 62 thereon that mates with the openings 50 of the rung walls 38, 40, 42, 44. Thus, the snap plug 32 can include four projections 58 to mate with each of the four transverse openings 50 at an end margin of the rungs 26. In other embodiments, the snap plug 32 can contain three projections 58 to mate with the horizontal upper wall 38 and each of the vertical first and second side walls 42, 44. In some embodiments, the snap plug 32 can contain projections 58 that do not engage with any opening 50 during installation. The projection length is generally selected so that it is of a sufficient length to engage openings 50. The vertical web 24 of the rails 22a, 22b contains an opening 60 sized and shaped to receive projections 58 while not allowing passage of the main body 54, such that when an axial opening 49 of the rung 26 is aligned with the vertical web opening, the projections pass through opening and into the open end 28, 30 of the rung 26. Thus, the main body 54 of the snap plug 32 remains on an outboard side of the rail 24, while the projections 58 pass through to an inboard side of the rail and into the interior space 46 of the rung 26.

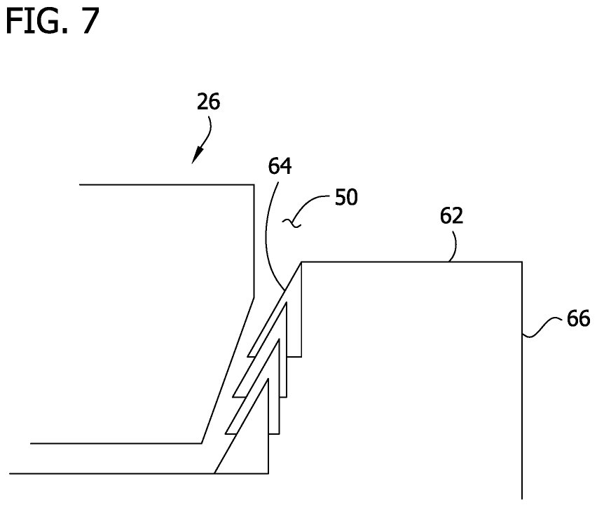

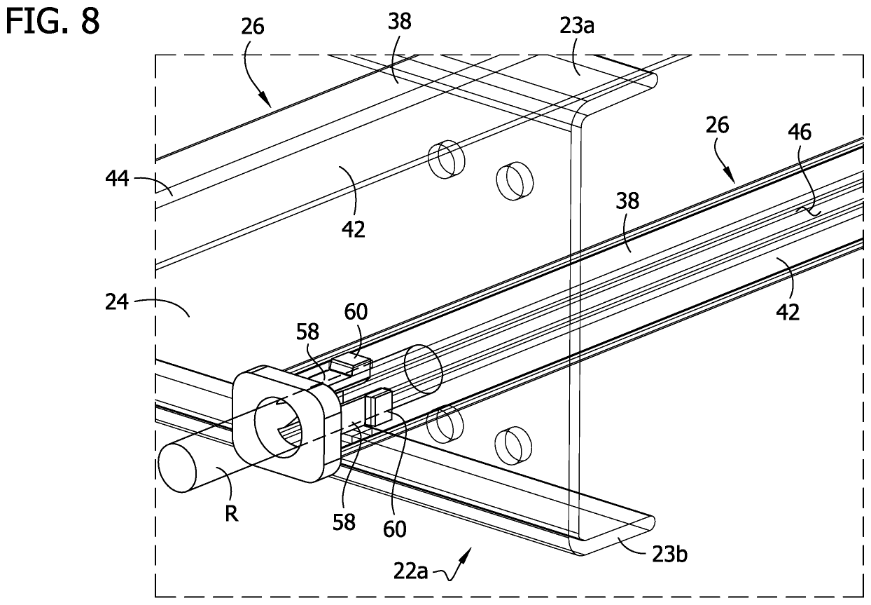

Each barb 62 includes a near end surface 64 that is angled (e.g., less than 45 degrees, less than 90 degrees) with respect to a vertical axis. In contrast, a far end surface 66 of each barb 62 can extend generally parallel to a vertical axis. The near end surface 64 provides a ramp surface for guiding the barb 62 into a respective transverse opening 50 in the rung 26. In one embodiment, the near end surface 64 of the barbs 62 can comprise a serrated surface to promote better engagement and interlocking of the barbs with the transverse openings 50 in the rung 26 (FIG. 7). In the illustrated embodiment, outer surfaces 70 of the projections 58 are generally flat and extend generally orthogonally to the inner surface of the main body 54. In some embodiments, inner surfaces 72 of the projections 58 are generally tapered inward toward the longitudinal axis of the snap plug 32 such that the inner surfaces table toward a central longitudinal axis of the snap plug as they extend from the main body 54. In this way, the interior opening 56 of the snap plug 32 is generally conical in shape. This allows for insertion of a rod R (FIG. 8) into the opening 56 of the main body 54 during installation of the snap plug, which, with optional hammering, pushes against the tapered inner surfaces 72 of the projections 58 to force the projections into a more open position, thereby allowing better engagement of the barbs 62 with rung openings 50 and eliminating any drawback of the snap joints.

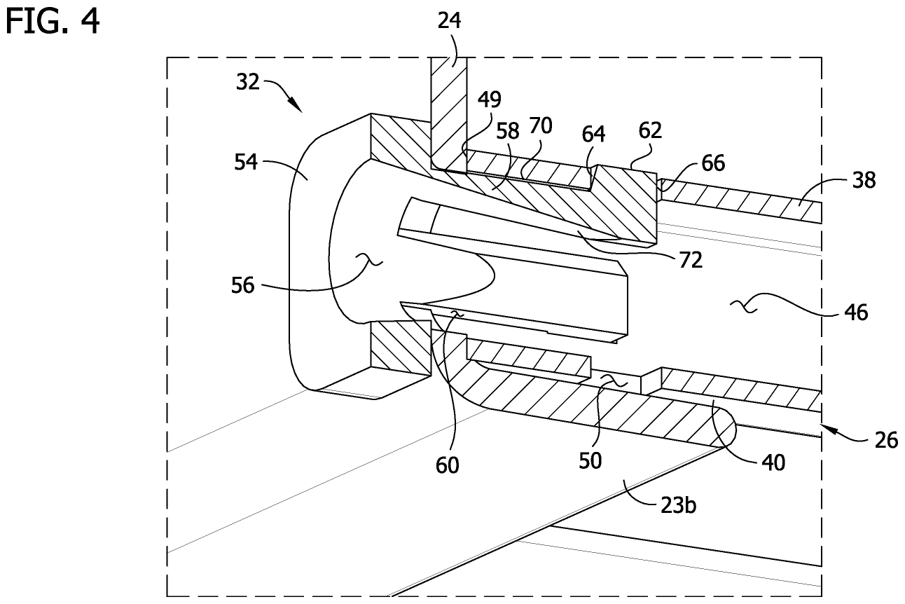

Referring to FIG. 4, in one embodiment, the bottom flange 23b of the rail 22a, 22b can include an opening (not shown) corresponding to a transverse opening 50 in the horizontal bottom wall 40. The opening in the rail 22a, 22b can be sized and shaped to receive a flat head rivet that can be glued into the opening to prevent vertical movement of the rung 26.

In one embodiment, the plug 32 is constructed of a polymer, for example. In various embodiments, the hardness of the plug 32 is greater than the hardness of the rung 26.

Accordingly, another aspect of the present disclosure is a method of coupling the rungs 26 to the rails 22a, 22b to form the cable tray assembly 20. The method generally comprises aligning a rung 26 with the vertical web opening 60 in one of the rails 22a, 22b such that the axial opening 49 is aligned with the vertical web opening 60. A snap plug 32 is then inserted, as described above, through opening 60 in the rail 22a, 22b and into the axial opening 49 in the rung 26 such that the projections 58 extend into the interior space 46 of the rung. The inserting step may require hammering or some other mechanical force exerted against an exterior surface of the main body 54 of the snap plug 32. Fully inserting the projections 58 into the interior space 46 causes the barbs 62 to be aligned with the transverse openings 50 in the rung 26. The near surfaces 64 of the barbs 62 will ride up along the edge of the transverse openings 50 causing the barbs to be received in the openings locking the snap plug 32 in place. Optionally, a rod R can be placed into the snap plug main body opening 56 to force the projection 58 outward to promote better engagement of the barbs 62 with the rung openings 50. In particular, the outward spreading of the projections 58 further inserts the barbs 62 into the transverse openings 50 which pulls the rung 26 toward the rail 22a, 22b further securing the rung to the rail. In some embodiments, a rivet, optionally with glue, is placed through an opening in the bottom flange 23b of the rail 22a, 22b, and through an opening 50 in the horizontal bottom wall opening 50 of the rung 26 to eliminate vertical movement of the rung 26. This process is repeated on the opposite end of the rung 26 and for each additional rung to complete the cable tray 20.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods] without departing from the scope of the invention, it is intended that all matter contained in the above description and shown in the accompanying drawings shall be interpreted as illustrative and not in a limiting sense.

1. A cable tray comprising:
a pair of generally parallel spaced-apart side rails, each side rail defining a plurality of openings;
rungs extending between the rails at intervals spaced along the rails, wherein each rung comprises at least two side walls, wherein each rung has opposite open ends generally aligned with respective openings in the side rails, wherein end portions of each rung define a transverse opening; and
a plurality of snap plug fasteners fastening the rungs to the side rails, each snap plug fastener including a main body abutting an outboard surface of one of the side rails, and a projection extending through one of the openings in the side rail and into one of the open ends of one of the rungs, wherein the projection includes a barb received in one of the transverse openings in the rung.

2. The cable tray of claim 1, wherein the rails and rungs are constructed from fiberglass.

3. The cable tray of claim 1, wherein the plurality of snap plug fasteners are constructed from a polymer.

4. The cable tray of claim 3, wherein a hardness of the snap plug fasteners is greater than a hardness of the rails and rungs.

5. The cable tray of claim 1, wherein the projection and barb comprise a first projection and first barb, wherein the snap plug includes a second projection having a second barb disposed thereon, the second barb being received in one of the transverse openings in the rung, the transverse opening receiving the first barb being formed in a separate side wall from the transverse opening receiving the second barb.

6. The cable tray of claim 1, wherein the main body of the snap plug fastener defines an opening in a central portion thereof.

7. The cable tray of claim 1, wherein the projections of the snap plug fasteners have an outer surface configured to engage the cable tray rung, and an inner surface disposed toward an interior opening of the snap plug fastener, wherein the outer surface of the projection is substantially planar.

8. The cable tray of claim 7, wherein the inner surface of the projection tapers inward from a first end of the projection to a second end of the projection.

9. The cable tray of claim 1, wherein the barbs comprise a ramp surface and an end surface, wherein the ramp surface and the end surface are substantially planar.

10. The cable tray of claim 9, wherein the ramp surface of the barb is angled with respect to a vertical axis of the snap plug fastener.

11. The cable tray of claim 10, wherein the angled ramp surface is serrated.

12. A snap plug fastener for coupling a cable tray rung to a cable tray rail, the fastener comprising:
a main body defining a central opening; and
a plurality of projections extending outward from the main body, each projection including a barb disposed on an end of the projection, the projections being configured to extend through aligned openings in the cable tray rail and rung, and the barb being configured to be received in a transverse opening in the rung to secure the rung to the rail.

13. The snap plug fastener of claim 12, wherein the main body comprises a plate.

14. The snap plug fastener of claim 12, wherein the projections have an outer surface configured to engage the cable tray rung, and an inner surface facing a central axis of the snap plug fastener, wherein the outer surface extends orthogonally from the main body.

15. The snap plug fastener of claim 14, wherein the inner surface of the projection tapers inward toward the central axis of the as the projection extends away from the main body.

16. The snap plug fastener of claim 12, wherein the barb comprises a ramp surface and an end surface, wherein the ramp surface and the end surface are substantially planar.

17. The snap plug fastener of claim 16, wherein the ramp surface of the barb is angled with respect to a vertical axis of the snap plug fastener.

18. The snap plug fastener of claim 17, wherein the angled ramp surface is serrated.

19. A method of coupling a cable tray rung to a cable tray rail, the method comprising;
aligning an opening defined by a vertical web of the cable tray rail with an open end of the cable tray rung, wherein the cable tray rung has an end portion defining a plurality of transverse openings;
inserting a snap plug fastener through the vertical web opening and into the open end of the cable tray rail, such that barbs disposed on ends of projections of the fastener are received in the transverse openings in the cable tray rung; and
inserting a rod into the snap plug fastener such that the rod engages inward-facing surfaces of the projections to force the barbs outward locking the barbs in the transverse openings.

20. The method of claim 19, wherein the method further comprises inserting a rivet through an opening defined in a lower flange of the cable tray rail and a transverse opening defined by a bottom wall of the cable tray rung.
